(19) United States
(12) Patent Application Publication
(10) Pub. No.: US 2015/0003124 A1
(43) Pub. Date: Jan. 1, 2015

(54) HIGH-FREQUENCY CURRENT REDUCTION DEVICE

(71) Applicants: Takuya Sakai, Tokyo (JP); Satoshi Azuma, Tokyo (JP)

(72) Inventors: Takuya Sakai, Tokyo (JP); Satoshi Azuma, Tokyo (JP)

(73) Assignee: Mitsubishi Electric Corporation, Tokyo (JP)

(21) Appl. No.: 14/368,182

(22) PCT Filed: May 29, 2012
(86) PCT No.: PCT/JP2012/063692

§ 371 Date: Jun. 23, 2014

(30) Foreign Application Priority Data
Jan. 27, 2012 (JP) 2012-014852

(51) Int. Cl. H02M 1/08; H02M 5/458

(52) U.S. Cl. CPC H02M 1/08; H02M 5/4585; H02M 2001/0038
USPC 363/37; 363/44

(57) ABSTRACT

In a system line for supplying power from an AC power source to a load through a converter and an inverter, a noise reduction unit is connected to a single connection line between the AC power source and the converter. In the noise reduction unit, a current transformer detects a noise current flowing through the connection line after converting it to a voltage, and the detected voltage V1 is supplied through a filter device to a voltage amplifier followed by being voltage-amplified and applied to a capacitor. The capacitor is connected to an injection point on the connection line, so that a high-frequency current in the same direction as the noise current is supplied to the converter from the connection line, to thereby reduce a high-frequency noise current at the AC power source side.

### TECHNICAL FIELD

This invention relates to a high-frequency current reduction device that reduces a high-frequency current generated, for example, in a power conversion device and the like that is connected to an AC power source and outputs a given AC voltage.

### BACKGROUND ART

Conventional conductive noise filters as high-frequency current reduction devices are applied to such systems that include, for example, a rectifier for converting an output of an AC voltage source to a DC voltage, and a power converter for converting a DC voltage to an AC voltage by use of switching operations by power semiconductor elements. Such conductive noise filters are provided with: a common-mode voltage detection means that detects, through a grounded capacitor connected to a line between the AC voltage source and the rectifier, a common-mode voltage generated at the time of switching operations by the power semiconductor elements; and a cancelling voltage source that generates, based on the detected common-mode voltage, a cancelling voltage with the same magnitude as the common-mode voltage but a polarity opposite thereto, and then superposes the cancelling voltage in between the AC power source and a connection point of the grounded capacitor on the line to thereby cancel the common-mode voltage (for example, Patent Document 1).

### CITATION LIST

### Patent Document

Patent Document 1: Japanese Patent Application Laid-open No. 2010-057268

### SUMMARY OF THE INVENTION

### Problems to be Solved by the Invention

The conventional high-frequency current reduction devices are configured as described above and work to detect a high-frequency common-mode voltage so as to reduce the common-mode current; however, with respect to a noise current in a normal mode, there is a problem that no consideration on its reduction is made other than that by an X capacitor and thus the reduction is insufficient.

Meanwhile, since the grounded capacitor is used as the common-mode voltage detection means, an impedance of its detection circuit is low, and thus the detection value becomes smaller. As a result, the cancelling voltage generated based on the detection value becomes smaller too, so that the common-mode current can not be reduced efficiently.

Furthermore, in circuit systems of the conventional devices, there is a problem that a frequency that maximizes an amplification factor (hereinafter, referred to as a gain) of an operational amplifier, coincides with a frequency at which a phase is inverted due to, for example, a delay time of an amplifier circuit including the operational amplifier (this results in amplification of noise), so that the amplifier circuit does not work stably when its gain is increased for noise reduction.

This invention has been made to solve the problems as described above, and an object thereof is to achieve a high-frequency current reduction device which can efficiently reduce both of the noise currents of a normal-mode noise and a common-mode noise.

### Means for Solving the Problems

A high-frequency current reduction device according to the invention comprises a noise reduction unit interposed between a first electric device and a second electric device by way of a single connection line between the first electric device and the second electric device, for reducing a high-frequency noise current flowing through the connection line from the first electric device. The noise reduction unit comprises: a detection unit that detects a noise current flowing through the connection line as a voltage; a filter device that extracts a desired high-frequency component from the detected voltage by the detection unit; a voltage amplifier that amplifies an output from the filter device; and a current injection means that includes a capacitor whose one terminal is connected to an injection point that is placed on the connection line and nearer to the second electric device than to the detection unit between the first electric device and the second electric device, and that injects a high-frequency current into the connection line. The current injection means applies to the other terminal of the capacitor, an output voltage from the voltage amplifier to thereby inject the high-frequency current in almost the same direction as the noise current, into the connection line.

### Effect of the Invention

According to the invention, the noise current flowing through the connection line is detected by the noise reduction unit interposed between a first electric device and a second electric device by way of a single connection line therebetween, so that the noise current is reduced by the high-frequency current generated based on the detected value. Thus, it is possible to reduce both of the noise currents of a normal-mode noise and a common-mode noise, included in a line current flowing through the connection line.

Further, since the current injection means supplies the high-frequency current in almost the same direction as the noise current to the connection line at nearer to the second electric device than to the detection unit, the high-frequency current becomes a noise current that is to flow from the connection line to the second electric device, so that the noise current flowing through the connection line from the first electric device can be reduced efficiently. Furthermore, since the current injection means injects the high-frequency current using the capacitor, it is possible to use the capacitor also as a high-pass filter. Thus, by adjusting the constant of the capacitor, the voltage amplifier can be protected, and an output current in a low-frequency band can be reduced.

Further, since the filter device is provided on the input side of the voltage amplifier, it is possible to control a factor that increases the noise current, to thereby enhance the gain of the voltage amplifier at the frequency subject to noise reduction. Thus, the noise current can be reduced efficiently in a highly reliable manner.

### BRIEF DESCRIPTION OF THE DRAWINGS

FIG. 1 is a diagram showing a configuration of a high-frequency current reduction device according to Embodiment 1 of the invention.

FIG. 2 is a connection diagram showing a connection example of the high-frequency current reduction device according to Embodiment 1 of the invention.

FIG. 3 is a circuit diagram showing a detail of a converter according to Embodiment 1 of the invention.

FIG. 4 is a circuit diagram showing a detail of an inverter according to Embodiment 1 of the invention.

FIG. 5 is a connection diagram showing a connection example of a high-frequency current reduction device according to Embodiment 2 of the invention.

FIG. 6 is a connection diagram showing a connection example of a high-frequency current reduction device according to Embodiment 3 of the invention.

FIG. 7 is a diagram showing a configuration of a high-frequency current reduction device according to Embodiment 4 of the invention.

FIG. 8 is a connection diagram showing a connection example of a high-frequency current reduction device according to Embodiment 5 of the invention.

FIG. 9 is a connection diagram showing a connection example of a high-frequency current reduction device according to another case of Embodiment 5 of the invention.

### MODES FOR CARRYING OUT THE INVENTION

### Embodiment 1

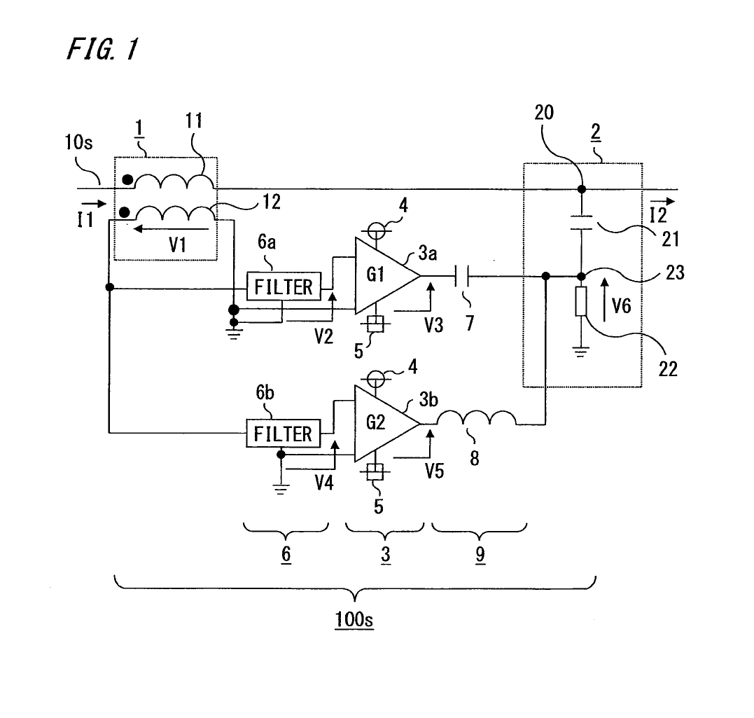

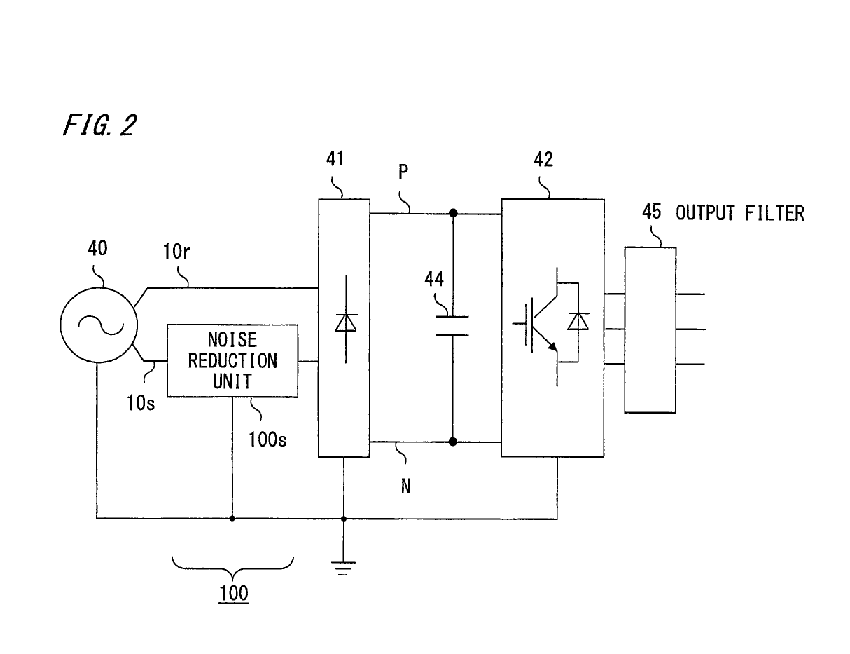

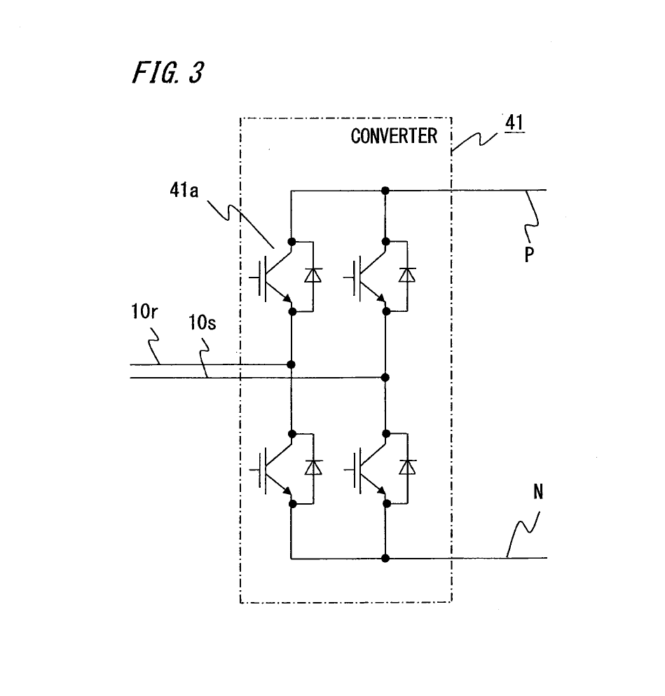

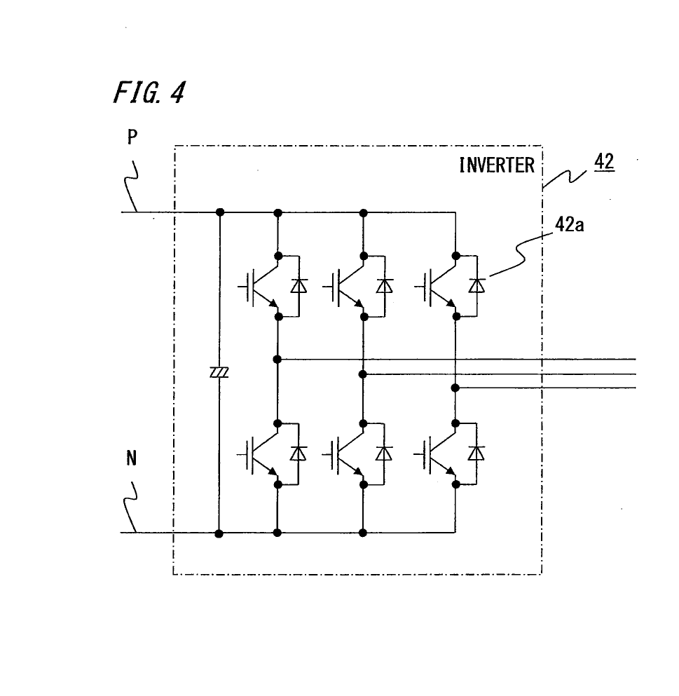

FIG. 1 to FIG. 4 show Embodiment 1 for carrying out the invention, in which FIG. 1 is a configuration diagram showing a configuration of a high-frequency current reduction device, FIG. 2 is a connection diagram showing a connection example of the high-frequency current reduction device, FIG. 3 is a circuit diagram showing a detail of a converter, and FIG. 4 is a circuit diagram showing a detail of an inverter.

The high-frequency current reduction device 100 is configured by a noise reduction unit 100s that is interposed between a single-phase AC power source 40 as a first electric device and a converter 41 as a second electric device, by way of one (connection line 10s) of two connection lines 10s, 10r that are AC output lines connecting the AC power source 40 and the converter 41. This device serves to reduce a noise current I1 that is a high-frequency component in a line current flowing through the connection line 10s from the AC power source 40.

As shown in FIG. 1, the noise reduction unit 100s includes a current transformer 1 as a detection unit, an injection circuit 2 as a current injection means, a voltage amplifier 3, a filter device 6 and an output filter 9.

The current transformer 1 includes a main winding 11 as a conductive line serially connected to the connection line 10s, and a winding 12 for current detection (hereinafter, referred to as a detection winding 12), and detects the high-frequency noise current I1 flowing through the connection line 10s after converting it to a voltage V1. The main winding 11 and the detection winding 12 are wound around an unshown core in the same winding direction by a predetermined number of times, in this embodiment, four times each.

Meanwhile, the injection circuit 2 is configured by connecting a capacitor 21 for voltage application and a grounded resistor 22. One terminal of the capacitor 21 is connected to an injection point 20 placed on the connection line 10s and nearer to the converter 41 than to the current transformer 1, and the other terminal is grounded through the grounded resistor 22. Note that the configuration may be provided with a capacitor instead of the grounded resistor 22.

An output of the detection winding 12 of the current transformer 1 is supplied through the filter device 6 to a positive-side input terminal of the voltage amplifier 3 followed by being voltage-amplified by a semiconductor switching element as an amplifier element, and is then applied, as an output voltage V6, to a connection point 23 between the capacitor 21 and the grounded resistor 22 through the output filter 9. Note that the other terminal of the detection winding 12 is grounded.

In the injection circuit 2, when the voltage is applied to the connection point 23, a voltage across the capacitor 21 changes, so that a high-frequency current in the same direction as the noise current I1 is supplied from the connection line 10s to the converter 41.

The filter device 6 serves to extract a desired high-frequency component from the output (voltage V1) of the detection winding 12, and is configured with a single filter circuit or a plurality of filter circuits 6a, 6b which are connected in parallel, in series, or series-parallel multi-stage. By adjusting each constant of the filter circuits 6a, 6b, their respective pass frequency ranges are adjusted, and further, an amplitude ratio and a phase difference are adjusted between the detected voltage V1 and the output voltage V2, V4 of each filter circuit 6a, 6b at their respective pass frequencies. The filter device 6 is set, for example by combining a plurality of high-pass/low-pass filters so that the amplitude and phase of the detection value (voltage V1) are adjusted individually for different frequencies, to thereby enhance a noise reduction effect for a frequency at which a noise is generated in a large extent.

In this case, the filter device 6 is configured with parallel-connected two filter circuits 6a, 6b that respectively restrict different frequency components from passing therethrough with respect to the voltage V1 detected by the current transformer 1. Meanwhile, the voltage amplifier 3 comprises a voltage amplifier 3a that amplifies up to G1(gain)-fold the output voltage V2 of the filter circuit 6a to thereby generate an output voltage V3, and a voltage amplifier 3b that amplifies up to G2(gain)-fold the output voltage V4 of the filter circuit 6b to thereby generate an output voltage V5.

Further, the output filter 9 includes a capacitor 7 provided as an output filter of the voltage amplifier 3a, and a reactor 8 provided as an output filter of the voltage amplifier 3b.

Note that, here, although description is directed to a case where the configuration is provided by the two voltage amplifiers 3a, 3b, the number of such parallel circuits may be adjusted depending on the magnitude of noise or a target frequency range of the circuit to be connected, for example, by setting the number of circuits constituting the voltage amplifier 3 to only one or three in parallel. Further, for the output filter 9, the number may also be changed as appropriate.

Each of the voltage amplifiers 3a,3b includes power terminals 4,5 for receiving a power supply for activation itself and an operational amplifier, and the operational amplifier includes a MOSFET as a semiconductor switching element for voltage amplification. The power supply for activation is received through the power terminals 4, 5 from an unshown external power source.

The voltage V1 detected by the detection winding 12 is input to the voltage amplifiers 3a, 3b through their respective filter circuits 6a, 6b followed by being voltage-amplified there, and then the amplified voltages are applied as output voltages V3 and V5 of AC components, to a connection point 23 of the injection circuit 2 through the output filter 9 (capacitor 7, reactor 8).

Such a phenomenon in which the voltage amplifiers 3a,3b amplify the noise, occurs at a phase-inversion frequency at which the phase of the noise current and each phase of the output currents of the voltage amplifiers 3a,3b are inverted to each other due to a characteristic, such as, an impedance of the circuit in which the respective voltage amplifiers 3a,3b are connected, a delay time of unshown operational amplifiers contained in the voltage amplifiers 3a,3b, or the like; or at a frequency at which a resonance arises due to an impedance of the system line or wirings, or an impedance of the electric device connected to the connection line. By adjusting the capacitance of the capacitor 21 in the injection circuit 2 or the constant of the output filter 9 (capacitor 7, reactor 8) or the filter circuits 6a, 6b, it is possible to adjust each of the above frequencies and a gain thereat. For example, it is possible to make an adjustment to set the above frequency away from a frequency at which noise reduction requirement is defined by a standard. Meanwhile, it is allowed to adjust the frequency that causes noise amplification to become away from the target frequency by connecting a capacitor and the like, to the connection lines 10s, 10r outside of the high-frequency current reduction device 100.

Meanwhile, it is possible to adjust the phase of the detection value at each frequency by serially connecting a capacitor and the like to in the configuration of the filter circuits 6a, 6b. If the high-frequency currents output from the voltage amplifiers 3a, 3b have a phase that is coincide with that of the noise current I1, the reduction effect on the noise fed from the AC power source 40 emerges largely, whereas if the currents have the phases largely deviated therefrom, a phenomenon of amplifying the noise occurs. Thus, by adjusting the constants of the filter circuits 6a, 6b and the output filter 9 to thereby adjust the frequency and the gain so that the gain in a frequency band that requires noise reduction becomes larger and the phase difference in the frequency band is eliminated, it is possible to achieve a large noise reduction effect.

As to the respective filter circuits 6a, 6b, their circuit constants are adjusted so that respective frequencies to be amplified by the two voltage amplifiers 3a, 3b are adjusted to be not coincide with each other, as well as their gains in a frequency band not required for noise reduction, such as, in a lower frequency range not required to be removed, for example, in a range around the carrier frequency of the inverter 42, are reduced. Thus, only the noise in a frequency band required for the reduction is reduced without causing amplification of noise. In this embodiment, the filter circuit 6a ensures a gain in a frequency band higher than a resonance frequency, whereas the filter circuit 6b ensures a gain in a frequency range lower than the resonance frequency.

As shown in FIG. 2, the thus-configured noise reduction unit 100s of the high-frequency current reduction device 100 is interposed in a system for supplying power from the AC power source 40 to an unshown load, for example, a three-phase motor, by way of one (connection line 10s) of the two connection lines 10s, 10r connecting the AC power source 40 and the converter 41. As shown in FIG. 3, the converter 41 is configured with full-bridge connected IGBTs 41a with diodes of inverse-parallel connection, as semiconductor switching elements, and converts a single-phase alternating current from the AC power source 40 to a direct current with a variable voltage, by controlling switching of the IGBTs 41a. The output of the converter 41 is input to the inverter 42 by means of DC bus lines (P, N) through a filter capacitor 44.

As shown in FIG. 4, the inverter 42 is configured with three-phase and full-bridge connected IGBTs 42a with diodes of inverse-parallel connection, as semiconductor switching elements, and operates in a pulse width modulation mode in which a direct current is converted to a three-phase alternating current with a variable voltage and variable frequency, by controlling switching of the IGBTs 42a using a PWM signal generated by comparing in magnitude a phase-voltage command with a carrier of a triangle wave or saw-tooth wave having a predetermined frequency. The output of the inverter 42 is supplied to the load by means of AC output lines through an output filter 45.

A system line is configured with the aforementioned AC power source 40, converter 41, filter capacitor 44, inverter 42, output filter 45 and load.

Note that the AC power source 40 has an electrostatic stray capacitance relative to the ground, and as well known in the art, the converter 41, the inverter 42 and the filter capacitor 44 are connected to the ground (GND) through an unshown frame or casing, thus each having an electrostatic stray capacitance relative to the ground, so that a common-mode current flows through each electrostatic stray capacitance relative to the ground. This grounding situation is shown in FIG. 2.

Next, an operation of the noise reduction unit 100s will be described. The current transformer 1 detects using the detection winding 12, the voltage V1 generated due to the high-frequency current (noise current I1) flowing through the connection line 10s, that is, the main winding 11, from the AC power source 40. Although the high-frequency current subject to noise reduction generally falls in a band of 150 kHz to 30 MHz, it is possible to detect the voltage without being limited to that band. Note that the voltage V1 is generated in proportional to the inductance of the current transformer 1 and the frequency.

The voltage V1 detected by the current transformer 1 is input to the filter circuits 6a, 6b, respectively. Then, at the filter circuit 6a, the voltage V2 is output with a gain and a phase having been adjusted individually for each frequency in a high-frequency band. This voltage is amplified up to G1(gain)-fold by the voltage amplifier 3a and then output therefrom as the voltage V3. Because the voltage V3 passes through the capacitor 7 provided as a high-pass filter, its DC component is removed, so that its high-frequency component is applied to the connection point 23 of the injection circuit 2.

Meanwhile, at the filter circuit 6b, the voltage V4 is output with a gain and a phase having been adjusted individually for each frequency in a low-frequency band. This voltage is amplified up to G2(gain)-fold by the voltage amplifier 3b and then output therefrom as the voltage V5. Because the voltage V5 passes through the reactor 8 provided as a low-pass filter, its high-frequency component is removed, so that its low-frequency component is applied to the connection point 23 of the injection circuit 2.

Note that, because of providing the capacitor 7 and the reactor 8 that constitutes the output filter 9, the outputs of the respective voltage amplifiers 3a, 3b are not coupled together through a low-impedance connection line even when the outputs of the respective voltage amplifiers 3a, 3b are connected to the connection point 23, so that their mutual interference can be reduced.

The injection circuit 2 applies to the capacitor 21, the output voltages of the respective voltage amplifiers 3a,3b through the capacitor 7 and the reactor 8, so that the voltage across the capacitor 21 changes and thus high-frequency currents from the respective voltage amplifiers 3a,3b are injected in the injection point 20 of the connection line 10s. As a result, a high-frequency current in the same direction as the noise current I1 is injected into the connection line 10s from the injection circuit 2, and supplied to the converter 41.

Note that what has been described above is equivalent to a situation where: by the filter circuits 6a, 6b and the voltage amplifiers 3a, 3b, the inductance of the current transformer 1 is multiplied by a gain-number of times having been adjusted individually for each frequency, and the resultant inductance emerges in between the current transformer 1 and the injection circuit 2.

On this occasion, in the respective voltage amplifiers 3a, 3b, the internal semiconductor switching elements are switching-controlled to thereby control the respective output voltages V3, V5 so that the noise current I1 becomes closer to zero. As a result, a most portion of the noise current I2 flowing from the connection line 10s to the converter 41 is fed from the voltage amplifiers 3a, 3b through the injection circuit 2 as a high-frequency current, so that the noise current I1 flowing through the connection line 10s from the AC power source 40 can be reduced almost to zero.

As described above, according to this embodiment, the noise reduction unit 100s is connected to the single connection line 10s between the AC power source 40 and the converter 41, the noise current I1 is detected by the current transformer 1, and a high-frequency current in the same direction as the noise current I1 is injected in a place on the same connection line 10s nearer to the converter 41 than to the current transformer 1 to thereby reduce the noise current I1. Thus, the target to be suppressed is a high-frequency current generated by the converter 41 or the inverter 42, so that the propagation of the high-frequency current to the AC power source 40 can be reduced efficiently, regardless of the propagation path.

Further, the noise current I1 in the line current flowing through the connection line 10s can be reduced regardless of whether it is a normal-mode noise or a common-mode noise, i.e. in both cases. In particular, since a single-phase alternating current is dealt with in this embodiment, by means of the noise reduction unit 100s interposed in one connection line 10s, a normal-mode noise in the other connection line 10r can also be reduced.

Further, since a high frequency current with a frequency separated out by the filter device 6 and the output filter 9, is injected into the connection line 10s through the capacitor 21 of the injection circuit 2 followed by being supplied to the converter 41, the noise current I1 flowing through the connection line 10s from the AC power source 40 can be suppressed.

Further, as the voltage amplifier 3, a simple amplifier circuit using, for example, an operational amplifier can be applied, and thus it is possible to simplify the configuration.

Furthermore, because of the use of the current transformer 1 for noise detection, the filter device 6 and the voltage amplifier 3 can be insulated from the connection line 10s given as an AC output line, so that only the noise that is a frequency component to be reduced can be detected and injected as a high-frequency current. This makes it unnecessary to use high breakdown-voltage components for the filter device 6 and the voltage amplifier 3, to thereby achieve downsizing and cost reduction of the device.

Note that, as to the filter circuit 6a and the capacitor 7, only one of these components may be provided in the configuration by adjusting its circuit constant, depending on a noise occurrence condition. Likewise, as to the filter circuit 6b and the reactor 8, only one of these components may be provided in the configuration by adjusting its circuit constant.

Meanwhile, while the voltage V1 is detected by the current transformer 1, the input impedance of the voltage amplifier 3 is set to a large value so that the voltage across the detection winding 12 can be detected accurately. This is because the detection accuracy of the detected voltage V1 becomes lower as the input impedance is set smaller.

According to the conventional cases, since a capacitor is used for noise detection, the impedance of its detection circuit becomes smaller at the time of detecting a high-frequency noise current, thus generating just a little voltage, so that it is difficult to detect a small noise current and a noise current in a high-frequency band. In contrast, according to this embodiment, since the voltage detection is made in a state where the voltage V1 to be detected is generated by the current transformer 1, another noise reduction effect is superposed due to the impedance generated by the current transformer 1, to thereby accomplish an enhanced noise reduction effect.

Meanwhile, in this embodiment, since the two filter circuits 6a, 6b with different frequency characteristics are connected, there are cases where the output impedance of the current transformer 1 becomes smaller in a wide frequency range. On this occasion, by providing a buffer circuit on the output side of the current transformer 1, a high impedance can be kept so that the detection value of the current transformer 1 is prevented from being affected by a reduction in impedance due to connection of the filter circuits 6a, 6b. Thus, it becomes possible to detect a high-frequency current in the wide frequency range.

Meanwhile, in the detected voltage V1, there are mixed respective noises of frequency components at the frequencies including:

a phase-inversion frequency at which the phase of the detected voltage V1 and each phase of the output voltages V3, V5 of the voltage amplifiers 3a, 3b are inverted to each other due to a characteristic, such as, an impedance of the circuit in which the voltage amplifiers 3a, 3b are connected, a delay time of unshown operational amplifiers contained in the voltage amplifiers, and the like;

a resonance frequency due to an impedance of the wirings, the current transformer 1 and the like; and

a frequency in a low-frequency range that is unnecessary to be removed, such as, in the range around the frequency of the carrier of the inverter 42 when the inverter 42 is connected.

By reducing the gains of bands including these frequencies using the filter circuits 6a, 6b, it is possible not to amplify these noises but to reduce only the noise in a frequency band required for the noise reduction.

Further, by differentiating the frequency bands subject to amplification between the plurality of voltage amplifiers 3a, 3b, it is possible to parallel-drive the plurality of voltage amplifiers 3a, 3b, regardless of any issue on a characteristic difference between the respective voltage amplifiers 3a, 3b, so that a high-frequency large current can be supplied and thus the amount to be supplied from the AC power source 40 can be reduced. The plurality of voltage amplifiers 3a, 3b may instead reduce noise currents in the same frequency band, and if this is the case, a resistor may be used as the output filter 9.

Further, by adjusting the constants of the filter circuits 6a, 6b by use, for example, of a configuration in which capacitors are serially interposed in the filter circuits 6a, 6b, it is possible to adjust their phase-inversion frequencies at which the phases of the voltages V3, V5 output from the voltage amplifiers 3a, 3b are inverted relative to the detected voltage V1 so that the phases of the currents output from the voltage amplifiers 3a, 3b are inverted. This makes it possible to establish a margin between the current frequency subject to noise reduction and the phase-inversion frequency. Thus, it is possible for the voltage amplifiers 3a, 3b to have large gains for the noise in the frequency band required for the reduction, and to operate stably.

Further, by adjusting so as not to match each other, the phase-inversion frequencies at which the phases of the voltages V3, V5 output from the voltage amplifiers 3a, 3b are inverted relative to the detected voltage V1, a noise with a frequency unable to be amplified by the voltage amplifier 3a is amplified by the voltage amplifier 3b, and conversely, a noise with a frequency unable to be amplified by the voltage amplifier 3b is amplified by the voltage amplifier 3a, so that it is possible to achieve a noise reduction effect over a wide frequency band.

Furthermore, by adjusting the capacitance of the capacitor 21 in the injection circuit 2, the phase-inversion frequencies can be adjusted.

The constants of the filters are adjusted so that the frequency band subject to noise reduction is set to, for example, a frequency band of 150 kHz or more that is a frequency band defined by a noise standard, or a frequency band that is determined to have a large noise component on the basis of a noise-measurement result of the system line or bus line, in order to reduce noise current in that frequency band, efficiently.

Meanwhile, when the system line is grounded, with respect to the connection lines 10s,10r from the AC power source 40, the noise reduction unit 100s is connected to the connection line 10s that is not grounded. In this case, a power source voltage is applied between the capacitor 21 and the grounded resistor 22 in the injection circuit 2. Thus, the circuit constant of the injection circuit 2 is adjusted so as to set impedance viewed from the system line to function as a high-pass filter with the system line's frequency or more. This prevents the power source voltage from being applied to the outputs of the voltage amplifiers 3a, 3b. By thus setting the constant, the voltage amplifiers 3a, 3b can be protected from a high-frequency power source voltage. The high-pass filter for protection may be formed of an element other than the injection circuit 2.

Meanwhile, at the moment the AC power source 40 is activated for the system line, or because of a momentary drop or a voltage abnormality, an abnormal voltage emerges in the voltage at the connection point 23 of the injection circuit 2. In order to protect the voltage amplifiers 3a, 3b from the abnormal voltage, a protection circuit comprising a zener diode, a resistor and so on, is each interposed between arbitrary positions and the ground, said arbitrary positions being placed between the respective voltage amplifier 3a, 3b and the injection circuit 2. By doing so, the voltage amplifiers 3a, 3b can be protected from the abnormal voltage in the aforementioned situation.

Further, at the resonance frequency of the output filter 9 (capacitor 7 and reactor 8) connected to the output side of the two voltage amplifiers 3a,3b, an impedance between the two voltage amplifiers 3a,3b becomes lower; however, the respective voltage amplifiers 3a,3b can be protected by connecting resistors to the output side thereof. If this is the case, as such resistors, the resistors of the aforementioned protection circuits for the abnormal voltage may be used commonly.

Note that in the above embodiment, description has been made citing a case where the noise reduction unit 100s is configured with a circuit using an analog circuit of, such as, a resistor, a capacitor, a voltage amplifier and the like; however, it is allowable to substitute apart of or all of these components with a digital circuit, so that the noise reduction circuit may be configured with a DSP and a microcomputer. In this case, an analog filter for suppressing a gain for a high frequency may be used in combination. For example, when a digital circuit is applied to the filter device 6, there is a merit that the gain for a preset frequency can be lowered while ensuring the gain for another frequency therearound.

Meanwhile, the winding directions of the main-winding 11 and the detection winding 12 in the current transformer 1 may be opposite to each other. Any configuration may be applied as long as capable of detecting the noise current I1 flowing through the connection line 10s, and of supplying the high-frequency current in the same direction as the noise current I1 to the connection line from the voltage amplifier 3. Thus, it is allowable to inverse the polarity of the current transformer 1 and to inverse the polarity of the output of the voltage amplifier 3.

Meanwhile, in the above embodiment, description has been made to a case where the current transformer 1 is configured by winding the respective main winding 11 and detection winding 12 around the unshown core by the same number of times. However, the number of turns is not limited thereto, and thus the number of turns in the detection winding 12 may be N-times relative to the number of turns in the main winding 11. In this case, the detection value of the high-frequency current after voltage conversion becomes V1×N.

By thus making the number of turns in the detection winding 12 larger than the number of turns in the main winding 11 to thereby increase the detected voltage, the gains G1, G2 of the voltage amplifiers 3a, 3b can be set to be relatively small. This suppresses occurrence of a gain error and an offset error between the voltage amplifiers 3a, 3b, and it is possible to adjust a voltage of DC power source necessary for the voltage amplifiers 3a, 3b.

Furthermore, even if the current transformer 1 being compact in size and small in inductance is used, when the turn ratio N is set higher, it is possible to detect the noise current while suppressing reduction in the detected voltage.

Further, the current transformer 1 is assumed to comprise the main winding 11 and the detection winding 12 that are wound around a core, but it is not limited to thereto, and a similar effect is accomplished when it comprises, instead of the main winding 11, the connection line 10s penetrating through a ring-shaped core, and the detection winding 12 wound around the ring-shaped core. In this case, a portion that penetrates through the ring-shaped core is given as a conductive line, so that the current transformer 1 is made to include the conductive line serially connected to the connection line 10s and the detection line 12.

### Embodiment 2

In Embodiment 1, the noise reduction unit 100s is connected to only one of the two connection lines 10s, 10r between the single-phase AC power source 40 and the converter 41. In contrast, in a high-frequency current reduction device 100A according to Embodiment 2, noise reduction units 100s, 100r are connected to both of the connection lines 10s, 10r, respectively.

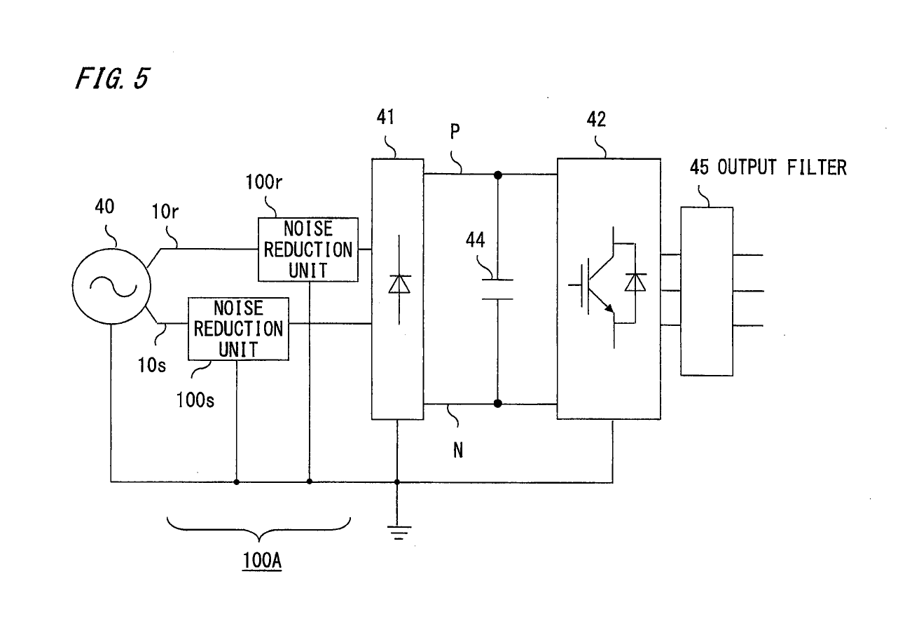

As shown in FIG. 5, the high-frequency current reduction unit 100A is configured with two noise reduction units 100s,100r interposed between the single-phase AC power source 40 and the converter 41 by way of the two connection lines 10s,10r connecting the single-phase AC power source 40 and the converter 41. The noise reduction unit 100s and the noise reduction unit 100r are individually interposed by way of the connection line 10s and the connection line 10r, respectively.

As illustrated in Embodiment 1, the noise reduction unit 100s includes a current transformer 1, an injection circuit 2, a voltage amplifier 3, a filter device 6 and an output filter 9, and, as described in Embodiment 1, serves to reduce a noise current I1 that is a high-frequency component in a line current flowing through the connection line 10s from the AC power source 40. Further, the noise reduction unit 100r also includes a similar configuration to the noise reduction unit 100s, that is, a current transformer 1, an injection circuit 2, a voltage amplifier 3, a filter device 6 and an output filter 9, and serves to reduce another noise current I1 that is a high-frequency component in a line current flowing through the connection line 10r from the AC power source 40.

According to Embodiment 1, it is unable to reduce a common-mode noise generated in the connection line 10r. In contrast, according to this embodiment, it is possible to reduce each noise current I1 in both of the connection lines 10s, 10r, regardless of whether it is a normal-mode noise or a common-mode noise, so that the propagation of all kinds of the high-frequency currents to the three-phase AC power source 40 can be suppressed efficiently.

Other configuration than the above and an effect thereof are similar to those in Embodiment 1.

### Embodiment 3

In Embodiment 1, the single-phase AC power source 40 is used as the first electric device, but in Embodiment 2, a three-phase AC power source 40A is used instead.

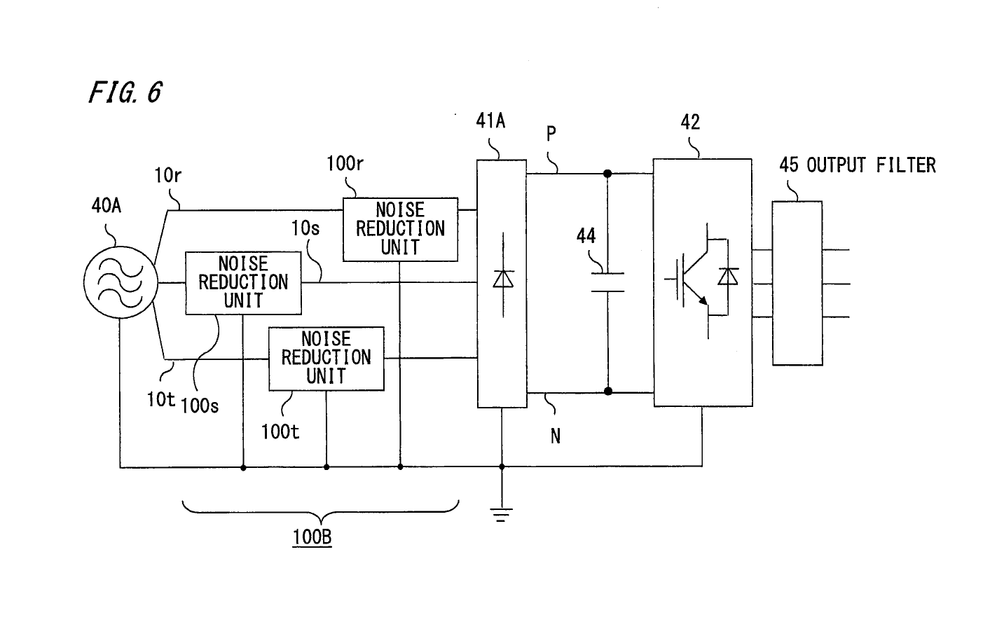

In this case, as shown in FIG. 6, a converter 41A as the second electric device is configured to convert three-phase AC power to DC power, and the system line is configured with the AC power source 40A, the converter 41A, a filter capacitor 44, an inverter 42, an output filter 45 and an unshown load.

To that end, a high-frequency current reduction device 100B is configured with three noise reduction units 100r, 100s, 100t interposed between the three-phase AC power source 40A and the converter 41A by way of three connection lines 10r, 10s, 10t that are AC output lines for the respective phases and connect the single-phase AC power source 40A and the converter 41A. The noise reduction unit 100r, the noise reduction unit 100s and the noise reduction unit 100t are individually interposed by way of the connection line 10r, the connection line 10s and the connection line 10t, respectively.

As illustrated in Embodiment 1, each of the noise reduction units 100r to 100t includes a current transformer 1, an injection circuit 2, a voltage amplifier 3, a filter device 6 and an output filter 9, and can reduce, by an operation similar to in Embodiment 1, both noise currents of a normal-mode noise and a common-mode noise in each line current flowing through each of the connection lines 10r to 10t from the AC power source 40A. Thus, it is possible to suppress efficiently the propagation of all kinds of the high-frequency currents to the three-phase AC power source 40A.

Note that, even when the three-phase AC power source 40A is used, it is allowable that among the three connection lines 10r, 10s, 10t, only one connection line 10s is provided with the noise reduction unit 100s. This affords an effect of reducing the noise current in the connection line 10s.

### Embodiment 4

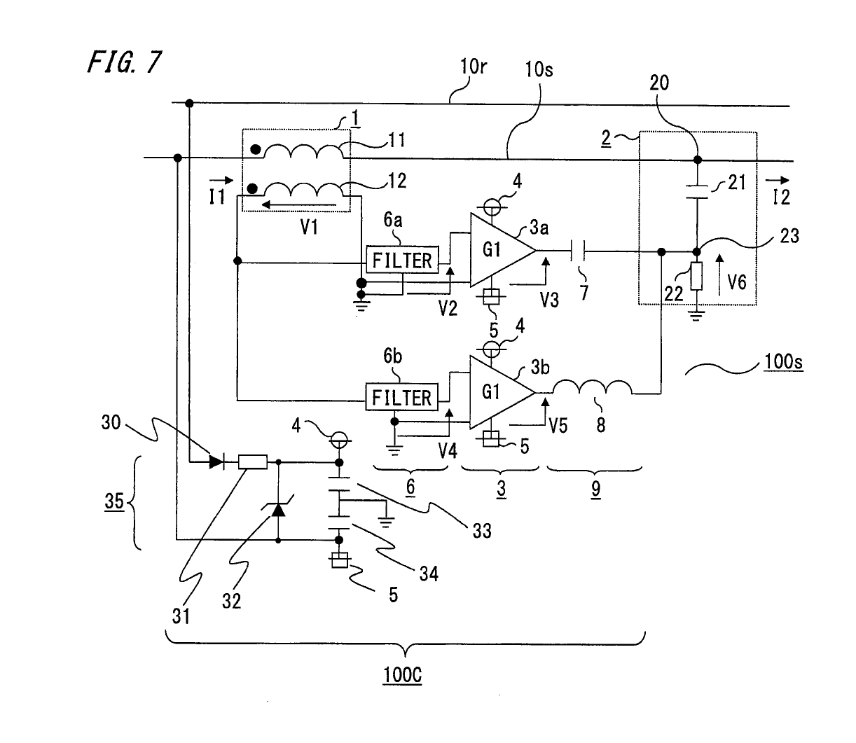

FIG. 7 is a configuration diagram showing a configuration of a high-frequency current reduction device 100C according to Embodiment 4. In FIG. 7, the high-frequency current reduction device 100C is configured by incorporating a rectifying power supply device 35 into the noise reduction unit 100s shown in FIG. 1. The rectifying power supply device 35 serves to convert the AC power from the connection lines 10s, 10r to two DC voltages of positive and negative levels, and supply them to the voltage amplifier 3 as activation power therefor. The rectifying power supply device 35 has a diode 30 whose positive-electrode side is connected to the connection line 10r and whose negative-electrode side is connected through a resistor 31 to a serial circuit of a capacitor 33 and a capacitor 34 at its capacitor 33-side. The capacitor 34-side of the serial circuit of the capacitor 33 and the capacitor 34 is connected to the connection line 10s, and a junction point between the capacitor 33 and the capacitor 34 is grounded. Further, a zener diode 32 is parallel-connected to the serial circuit of the capacitor 33 and the capacitor 34.

An AC voltage generated between the two connection lines 10s, 10r is half-wave rectified by the diode 30, and then voltage-divided by the resistor 31 and the zener diode 32, so that the two DC voltages of different voltage levels for activating the voltage amplifier 3 are given at both ends of the serial circuit of the capacitors 33, 34. Voltage terminals at both ends of the serial circuit of the capacitors 33, 34 are connected to the power terminals 4, 5 of the voltage amplifier 3, so that the activation power is supplied to voltage amplifier 3. Other configuration than the above is similar to that in Embodiment 1 shown in FIG. 1 to FIG. 4.

In this embodiment, since a DC power supply for activating the voltage amplifier 3 is established by receiving AC power from the connection lines 10s,10r, no separate power supplying is required. Further, in this embodiment, since a voltage adjustment is made by the zener diode 32, an insulation transformer or a converter is unnecessary therefor, which results in downsizing and cost reduction of the power supply section. The voltage adjustment method is not limited to this method, and a voltage may be supplied from the connection line as a power supply controlled by an insulation transformer, a DC/DC converter or the like.

Note that it is desirable that the rectifying power supply device 35 receive power from the connection lines 10s, 10r at nearer to the AC power source 40 than to the injection circuit 2. When the positions for receiving power are nearer to the AC power source 40 than to the injection circuit 2, since its noise current has been reduced and thus the noise fed into the voltage amplifier 3 through the rectifying power supply device 35 can be reduced, the reliability of the high-frequency current reduction device 100C is enhanced.

Further, in FIG. 7, although the DC power supply for activating the voltage amplifier 3 is established from the AC power source 40 using the connection lines 10s,10r, the DC power supply may be established using a DC voltage between the connection lines P,N on the output side of the converter 41. For example, the DC power supply may be established by connecting between the connection lines P, N, a serial circuit of plurality of capacitors, a resistor, a zener diode, a transformer, or a switching power supply. Instead, the DC power supply may be established by a power supply from the outside. On these occasions, in order to prevent the noise from coming around through the power terminals 4, 5, there are cases where a filter configured with a passive filter etc., becomes necessary on each of the input and output sides of the circuit for the power supply.

Further, in the embodiment, description has been made for the high-frequency current reduction device 100C having the noise reduction unit 100s that is provided with the rectifying power supply device 35; however, by providing the rectifying power supply device 35 to the high-frequency current reduction device 100A or 100B described in Embodiment 2 or 3, the DC power supply can be generated for the voltage amplifier 3 in each noise reduction unit of these devices. In the case of the high-frequency current reduction device 100B, the DC power supply for activating the voltage amplifier 3 may be established from the AC power source 40 using the connection lines 10s, 10t or the connection lines 10r, 10t.

### Embodiment 5

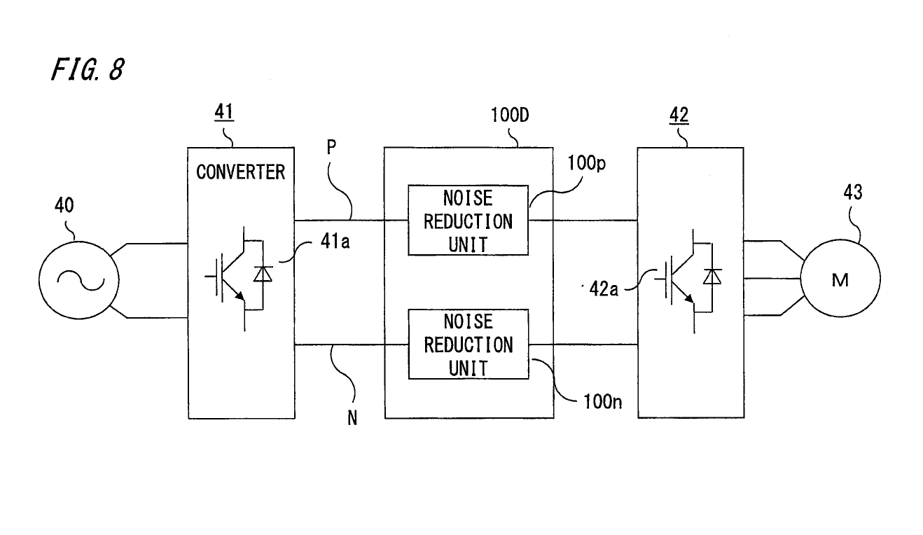

FIG. 8 shows a connection example of a high-frequency current reduction device 100D according to Embodiment 5.

As shown in FIG. 8, in a system for supplying power from a single-phase AC power source 40 to a three-phase motor 43 as a load, a converter 41 as the first electric device is connected to the AC power source 40, and the high-frequency current detection device 100D is interposed between the converter 41 and an inverter 42 as the second electric device by way of connection lines P,N as DC bus lines, to thereby reduce high-frequency noise currents flowing through the connection line P,N from the converter 41. The inverter 42 is connected at its AC output side, to the three-phase motor 43, to thereby activate the three-phase motor 43 by a three-phase alternating current with a variable voltage and variable frequency.

The high-frequency current reduction device 100D includes a noise reduction unit 100p connected to the connection line P and a noise reduction unit 100n connected to the connection line N, in which the respective noise reduction units 100p, 100n are similar to the noise reduction unit 100s described in Embodiment 1.

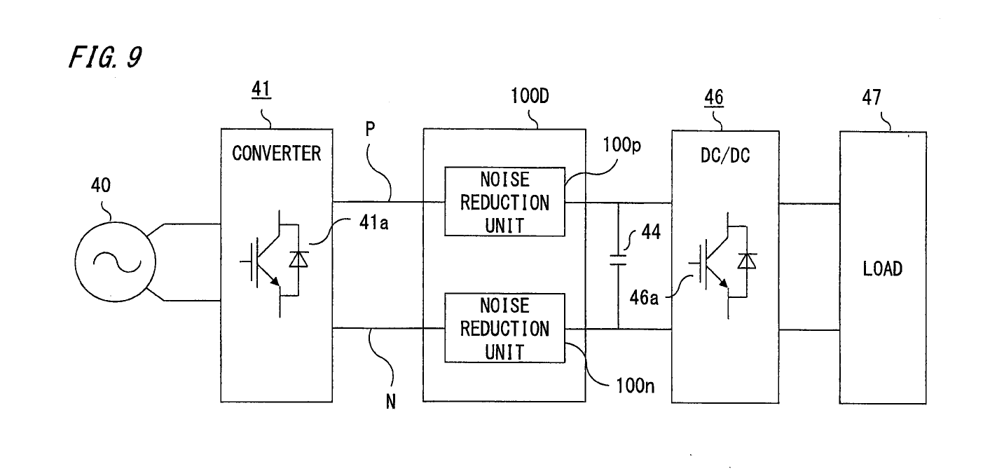

Meanwhile, FIG. 9 shows another connection example of the high-frequency current reduction device 100D. In this case, the converter 41 as the first electric device is connected to the AC power source 40, and the high-frequency current detection device 100D is interposed between the converter 41 and a DC/DC converter 46 as the second electric device by way of the connection lines P, N as DC bus lines, to thereby reduce high-frequency noise currents flowing through the connection line P, N from the converter 41. The DC/DC converter 46 includes IGBTs 46a with diodes of inverse-parallel connection, as semiconductor switching elements, and activates a DC load 47 while adjusting a DC output voltage from the converter 41.

Note that, although no wiring connected to the ground is shown in FIG. 8 and FIG. 9, the respective devices/units are assumed to be grounded.

In such a manner, the noise reduction units 100p, 100n may be connected to the connection lines P, N coupled to DC power, and this makes it possible to reduce the high-frequency noise current similarly to the previously-described respective embodiments.

In the case where the inverter 42 or the DC/DC converter 46 is coupled with the AC power source 40 as shown in FIG. 8 or FIG. 9, and a noise current in a low frequency range that is unnecessary to be removed, for example, in a frequency range around each switching frequency of them, is flowing mixedly through the connection lines P,N, the filter device 6 is set so that its gain in the above frequency band is reduced so as to input to the voltage amplifier 3, only a detected component in a frequency band that requires noise reduction whereby only a noise current with a frequency required for noise reduction is to be reduced. This suppresses the power consumption of the high-frequency current reduction device 100D.

Note that in the embodiment, the noise reduction unit 100p connected to the connection line P and the noise reduction unit 100n connected to the connection line N are provided; however, either one of them (connection line P) may be provided with a single noise reduction unit (100p).

Further, like Embodiment 4, a DC voltage supply for activating the voltage amplifier 3 may be established from the connection lines P, N. In this case, although power may be received from the connection lines P,N at any positions nearer to the converter 41 or nearer to the second device (inverter 42 or DC/DC converter 46), it is desirable to be received at the positions nearer to the converter 41. When the positions for receiving power are nearer to the converter 41 than to the injection circuit 2, since the noise currents flowing through the connection lines P,N have been reduced and thus the noise fed into the voltage amplifier 3 can be reduced, the reliability of the high-frequency current reduction device 100D is enhanced.

Furthermore, the DC voltage supply for activating the voltage amplifier 3 may be established by providing a rectifying circuit between AC output lines from the AC power source 40 or between two AC output lines among AC output lines from the inverter 42.

By the way, as semiconductor switching elements, for example, for the IGBTs 41a, 42a and 46a of the converter 41, the inverter 42 and the DC/DC converter 46 used in the respective embodiments, nowadays, such semiconductor switching elements are used that consist of a wide bandgap semiconductor formed of silicon carbide (SiC), a gallium nitride-family material, diamond or the like, and therefore, their switching-operation speeds have become much faster. However, in association with such faster speeds, an amount of noise generation tends to become increased. According to the high-frequency current reduction devices 100, 100A to 100D of the respective embodiments, even with the problem described above, it is possible to perform an operation for reducing the high-frequency noise current without selecting the kind of semiconductor switching element. Thus, it is possible to reduce efficiently the noise generated by the semiconductor switching element that is formed of silicon carbide etc., and is under a high-speed switching operation, to thereby resolve the demerit at the time of causing it to operate high-speed switching. Likewise, even in the case where the amplification in the voltage amplifier 3 is performed by a semiconductor switching element, such as a transistor or MOSFET formed of a wide bandgap semiconductor, such as silicon carbide, a gallium nitride-family material, diamond or the like, it is possible to diminish an effect due to noise occurrence, to thereby reduce the high-frequency noise current.

It should be noted that unlimited combination of the respective embodiments, modification of the embodiments and omission in the embodiments may be made in the present invention as appropriate without departing from the scope of the invention.

1. A high-frequency current reduction device which comprises a noise reduction unit interposed between a first electric device and a second electric device by way of a single connection line between the first electric device and the second electric device, for reducing a high-frequency noise current flowing through the connection line from the first electric device,
said noise reduction unit comprising:
a detection unit that detects a noise current flowing through the connection line as a voltage;
a filter device that extracts a desired high-frequency component from the detected voltage by the detection unit;
a voltage amplifier that amplifies an output from the filter device; and
a current injection portion that includes a capacitor whose first terminal is connected to an injection point that is placed on the connection line and nearer to the second electric device than to the detection unit between the first electric device and the second electric device, and that injects a high-frequency current to the connection line;
wherein the detection unit is configured with a detection transformer that includes a conductive line serially connected to the connection line and a winding for current detection, and
the current injection portion applies to a second terminal of the capacitor, an output voltage from the voltage amplifier to thereby inject the high-frequency current in almost the same direction as the noise current into the connection line.

2. The high-frequency current reduction device of claim 1, wherein the filter device extracts both a normal-mode high-frequency component and a common-mode noise.

3. The high-frequency current reduction device of claim 1, wherein the first and second electric devices are connected to each other by a plurality of connection lines and the noise reduction unit is provided individually for every one of all or a part of the plurality of connection lines.

4. (canceled)

5. The high-frequency current reduction device of claim 1, wherein the filter device is configured with at least one filter circuit, each filter circuit, to which the voltage amplifier is connected respectively, an output of each filter circuit is amplified by the respective voltage amplifier and input to the second terminal of the capacitor.

6. The high-frequency current reduction device of claim 5, wherein each filter circuit of the filter device is adjustable in its respective pass frequency range individually.

7. The high-frequency current reduction device of claim 1, wherein the filter device is set to adjust a frequency and restrict a component of the frequency from passing therethrough, said frequency being one of frequencies of the detected voltage, with which a phase of a current output by the voltage amplifier is inverted relative to a phase of the noise current.

8. The high-frequency current reduction device of claim 1, wherein the voltage amplifier is configured to output only a specific frequency component.

9. The high-frequency current reduction device of claim 8, wherein the voltage amplifier has an output filter to thereby output only the specific frequency component.

10. The high-frequency current reduction device of claim 1, wherein the current injection portion is capable of adjusting a phase-inversion frequency at which a phase of the output voltage output by the voltage amplifier is inverted relative to a phase of the detected voltage, by adjusting a capacitance of the capacitor.

11. The high-frequency current reduction device of claim 1, wherein an inverter of a pulse width modulation type is connected to the connection line, and the filter device restricts a frequency component from passing therethrough that is one of frequency components of the detected voltage and has a frequency lower than or equal to that of a carrier of the inverter.

12. The high-frequency current reduction device of claim 1, wherein the first electric device is an AC power source, and the second electric device is a converter that converts AC power from the AC power source to DC power.

13. The high-frequency current reduction device of claim 1, wherein the first electric device is a converter that converts AC power to DC power, and the second electric device is an inverter that converts the DC power from the converter to AC power.

14. The high-frequency current reduction device of claim 1, wherein the first electric device is a converter that converts AC power to DC power, and the second electric device is a converter that adjusts a DC output voltage from the above converter.

15. The high-frequency current reduction device of claim 11, wherein the inverter includes a semiconductor switching element, and is output-controlled by the element, wherein the semiconductor switching element is formed of a wide bandgap semiconductor.

16. The high-frequency current reduction device of claim 1, wherein at least one of the first electric device and the second electric device are power converting devices, each of which includes a semiconductor switching element, and is output-controlled by the element, wherein the semiconductor switching element is formed of a wide bandgap semiconductor.
